(19) United States
(12) Patent Application Publication
(10) Pub. No.: US 2026/0088886 A1
(43) Pub. Date: Mar. 26, 2026

(54) DEVICES, METHODS AND APPARATUSES FOR UPLINK TRANSMISSION

(71) Applicant: Nokia Technologies Oy, Espoo (FI)

(72) Inventors: Samantha CAPORAL DEL BARRIO, Aalborg (DK); Mihai ENESCU, Espoo (FI); Morten TOFT, Aalborg (DK); Matha DEGHEL, Massy (FR); Christian ROM, Aalborg (DK); Timo KOSKELA, Oulu (FI); Juha Pekka KARJALAINEN, Oulu (FI); Paolo BARACCA, Munich (DE)

(21) Appl. No.: 19/106,855

(22) PCT Filed: Aug. 11, 2023
(86) PCT No.: PCT/EP2023/072263

§ 371 Date: Feb. 26, 2025

(30) Foreign Application Priority Data
Sep. 30, 2022 (GB) 2214436.4

(51) Int. Cl. H04B 7/06; H04L 5/00; H04L 27/26; H04W 74/0833

(52) U.S. Cl. CPC H04B 7/06968; H04L 5/0051; H04L 27/2605; H04W 74/0833

(57) ABSTRACT

Embodiments of the present disclosure disclose devices, methods and apparatuses for uplink transmission using long CP. A terminal device receives, from a network device, a new transmission configuration indicator, TCI, state indication. The new TCI state indication indicates a new TCI state is to be used for uplink signal transmission. Then, the terminal device transmits, to the network device, at least one uplink signal using a long cyclic prefix, CP, in at least one uplink channel associated with the new TCI state.

### FIELD

This application claims priority from U.K. patent application no. 2214436.4 filed on Sep. 30, 2022. The contents of this earlier filed application are hereby incorporated by reference in their entirety.

### FIELD

Embodiments of the present disclosure generally relate to the field of communication, and in particular, to devices, methods, apparatuses and computer readable storage medium for uplink transmission.

### BACKGROUND

With the development of communication technology, multi-transmit and receive point (TRP) operation has been introduced to improve the performance of communication between terminal devices and network devices. Release 18 (Rel-18) introduces two timing advance (TA) loops for multi-TRP operation with multi-downlink control information (DCI) for multi-TRP enhancement. For multi-DCI based multi-TRP operation with two TAs, it supports configuring two TA groups (TAGs).

Two main options are currently discussed, in one option, a TAG may be associated with a TRP via a coreset pool index, and in the other option, a TAG may be associated with a transmission configuration indicator (TCI) state. In the former option, multi-TRP could have two or more TAGs associated to different TCI states. In the latter option, a TRP could have two or more TAGS associated to different TCI states. However, issues related TA may happen during initialization or activation of an additional TA loop and thus further improvement on uplink transmission is desirable.

### SUMMARY

In general, example embodiments of the present disclosure provide devices, methods, apparatuses and computer readable storage medium for uplink transmission using long CP.

In a first aspect, there is provided a terminal device. The terminal device may comprise one or more transceivers; and one or more processors communicatively coupled to the one or more transceivers, and the one or more processors are configured to cause the terminal device to: receive, from a network device, a new transmission configuration indicator, TCI, state indication, wherein the new TCI state indication may indicate a new TCI state is to be used for uplink signal transmission; and transmit, to the network device, at least one uplink signal using a long cyclic prefix, CP, based on the new TCI state.

In a second aspect, there is provided a network device. The network device may comprise one or more transceivers; and one or more processors communicatively coupled to the one or more transceivers, and the one or more processors are configured to cause the network device to: transmit, to a terminal device, a new transmission configuration indicator, TCI, state indication, wherein the new TCI state indication may indicate a new TCI state is to be used for uplink signal transmission; and receive, from the terminal device, at least one uplink signal using a long cyclic prefix, CP, based on the new TCI state.

In a third aspect, there is provided a method implemented at a terminal device. The method may comprise: receiving, from a network device, a new transmission configuration indicator, TCI, state indication, wherein the new TCI state indication may indicate a new TCI state is to be used for uplink signal transmission; and transmitting, to the network device, at least one uplink signal using a long cyclic prefix, CP, based on the new TCI state.

In a fourth aspect, there is provided a method implemented at a network device. The method may comprise: transmitting, to a terminal device, a new transmission configuration indicator, TCI, state indication, wherein the new TCI state indication may indicate a new TCI state is to be used for uplink signal transmission; and receiving, from the terminal device, at least one uplink signal using a long cyclic prefix, CP, based on the new TCI state.

In a fifth aspect, there is provided an apparatus of a terminal device. The apparatus may comprise: means for receiving, from a network device, a new transmission configuration indicator, TCI, state indication, wherein the new TCI state indication may indicate a new TCI state is to be used for uplink signal transmission; and means for transmitting, to the network device, at least one uplink signal using a long cyclic prefix, CP, based on the new TCI state.

In a sixth aspect, there is provided an apparatus of a network device. The apparatus may comprise: means for transmitting, to a terminal device, a new transmission configuration indicator, TCI, state indication, wherein the new TCI state indication may indicate a new TCI state is to be used for uplink signal transmission; and means for receiving, from the terminal device, at least one uplink signal using a long cyclic prefix, CP, based on the new TCI state.

In a seventh aspect, there is provided a terminal device. The terminal device may comprise at least one processor; and at least one memory including computer program codes, wherein the at least one memory and the computer program codes are configured to, with the at least one processor, cause the terminal device to: receive, from a network device, a new transmission configuration indicator, TCI, state indication, wherein the new TCI state indication may indicate a new TCI state is to be used for uplink signal transmission; and transmit, to the network device, at least one uplink signal using a long cyclic prefix, CP, based on the new TCI state.

In an eighth aspect, there is provided a network device. The network device may comprise at least one processor; and at least one memory including computer program codes, wherein the at least one memory and the computer program codes are configured to, with the at least one processor, cause the terminal device to: transmit, to a terminal device, a new transmission configuration indicator, TCI, state indication, wherein the new TCI state indication may indicate a new TCI state is to be used for uplink signal transmission; and receive, from the terminal device, at least one uplink signal using a long cyclic prefix, CP, based on the new TCI state.

In a ninth aspect, there is provided a non-transitory computer readable medium comprising program instructions for causing an apparatus to perform at least the method according to third or fourth aspect.

In a tenth aspect, there is provided a computer program comprising instructions, which, when executed by an apparatus, cause the apparatus at least to: receive, from a network device, a new transmission configuration indicator, TCI, state indication, wherein the new TCI state indication may indicate a new TCI state is to be used for uplink signal transmission; and transmit, to the network device, at least one uplink signal using a long cyclic prefix, CP, based on the new TCI state.

In an eleventh aspect, there is provided a computer program comprising instructions, which, when executed by an apparatus, cause the apparatus at least to: transmit, to a terminal device, a new transmission configuration indicator, TCI, state indication, wherein the new TCI state indication may indicate a new TCI state is to be used for uplink signal transmission; and receive, from the terminal device, at least one uplink signal using a long cyclic prefix, CP, based on the new TCI state.

In a twelfth aspect, there is provided a terminal device. The terminal device may comprise receiving circuitry configured to: receive, from a network device, a new transmission configuration indicator, TCI, state indication, wherein the new TCI state indication may indicate a new TCI state is to be used for uplink signal transmission; and transmit, to the network device, at least one uplink signal using a long cyclic prefix, CP, based on the new TCI state.

In a thirteenth aspect, there is provided a network device. The network device may comprise transmitting circuitry configured to: transmit, to a terminal device, a new transmission configuration indicator, TCI, state indication, wherein the new TCI state indication may indicate a new TCI state is to be used for uplink signal transmission; and receive, from the terminal device, at least one uplink signal using a long cyclic prefix, CP, based on the new TCI state.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example network environment in which example embodiments of the present disclosure may be implemented;

FIG. 1B illustrates another example network environment in which example embodiments of the present disclosure may be implemented;

FIG. 2 illustrates an example schematic drawing showing receiving power of uplink signals using a normal CP at two network devices;

FIG. 3 illustrates an example schematic drawing showing receiving power of uplink signals using a long CP at two network devices;

FIG. 4 illustrates an example signaling process for uplink transmission using a long CP upon activation of an additional TCI state according to some embodiments of the present disclosure;

FIG. 5 illustrates an example flowchart of a method implemented at a terminal device according to example embodiments of the present disclosure;

FIG. 6 illustrates an example flowchart of a method implemented at a network device according to example embodiments of the present disclosure;

FIG. 7 illustrates an example simplified block diagram of an apparatus that is suitable for implementing embodiments of the present disclosure; and

FIG. 8 illustrates an example of a computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or”includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a transmit receive point (TRP), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, configuring two TA loops and two TAG for multi-TRP operation are beneficial for multi-TRP enhancement. The multi-TRP operation may be intra-cell multi-TRP operation or inter-cell multi-TRP operation. A TRP may be a serving cell or another cell. In some embodiments, intra-cell may indicate a gNB which provides one or more beams for a user device for communication. In some embodiments, inter-cell may indicate a cell or cell group providing service for a user device for communication. In some embodiments, inter-cell may indicate two or more (physical) cells associate with one TRP respectively providing service for a user device, and the TRPs associated with the cells belong to a same or different gNBs.

In the multi-TRP operation, a TRP of the multiple TRPs performing data transmission towards a terminal device may be associated with TAG(s). In some embodiments, TAG may be associated to at least one of TCI state, corset pool index or physical cell identifier (PCI). For example, each TRP may provide a cell associated to a TAG having at least one of the corresponding TCI state, corset pool index or PCI. A TCI-state defines a quasi co-location (QCL) source and QCL type for a target reference signal and may indicate a transmission configuration which includes QCL-relationships between the downlink reference signals (RSs) in one RS set. TCI states may be dynamically sent over in DCI messages.

In Rel-18, two TA loops were introduced for multi-DCI based multi-TRP operation and two TAGs may be configured to a terminal device. In the case that two or more TAGS associated to different TCI states exist in the multi-TRP scenario, upon activation of an additional TCI state, it may need to initialize an additional TA loop for TA adjustment. If the additional TA loop for the additional TCI state is not initiated yet, UE can only use the previous TA loop for the additional TCI state, and sometimes, uplink data for the additional TCI state may be received outside of the CP length at the network device, resulting that the uplink data is received with poor signal to interference plus noise ratio (SINR) or even lost due to timing misalignment. In an UL TCI state switching case, it also requires initialization of an additional TA loop, and similar issue may occur.

Therefore, in order to enhance timing alignment operation and reduce the possibility that the uplink data for the additional TA loop is degraded or lost, an improved scheme to initialize or activate an additional TA loop upon activation of an additional TCI state is desirable.

According to embodiments of the present disclosure, a terminal device receives a new TCI state indication from a network device. The new TCI state indication may indicate a new TCI state is to be used for uplink signal transmission. Then, the terminal device transmits, to the network device, at least one uplink signal using a long CP based on the new TCI state.

In this way, the uplink signal transmission associated with the new TCI state is performed using a long CP instead of a normal CP. Since the long CP has a longer duration than the normal CP and thus it could support a delay more than twice as the normal CP. Therefore the embodiments of the present disclosure could absorb more delay and ensure detecting the uplink transmission for the new TCI state. Thus, it may be ensured that the uplink transmission for the new TCI state is less likely to be degraded or lost, and timing alignment operation may be enhanced.

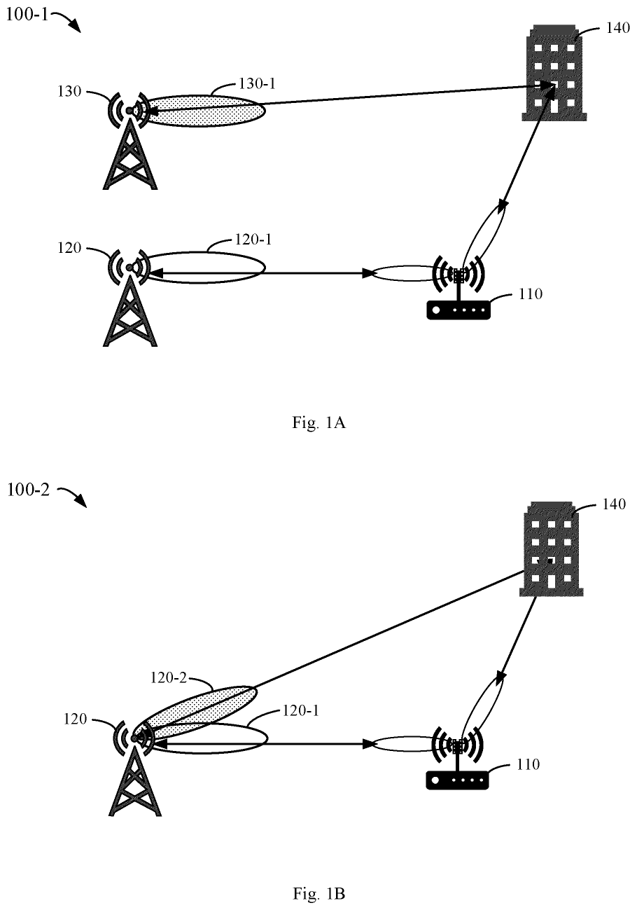

For illustrative purposes, principle and example embodiments of the present disclosure for the uplink transmission using long CP will be described below with reference to FIG. 1A to FIG. 8. However, it is to be noted that these embodiments are given to enable the skilled in the art to understand inventive concepts of the present disclosure and implement the solution as proposed herein, and not intended to limit scope of the present application in any way.

FIG. 1A illustrates an example network environment 100-1 in which example embodiments of the present disclosure may be implemented. The environment 100-1, which may be a part of a communication network, includes terminal devices and network devices.

As illustrated in FIG. 1A, the communication network 100-1 may include a terminal device 110 (hereinafter may also be referred to as user equipment 110 or a UE 110). The communication network 100-1 may further include a network device 120 and a network device 130 (hereinafter may also be referred to as a TRP or BS).

Each network device of these network devices may manage one or more cells. The network device 120 may be configured with a plurality of beams 120-1 which provides coverage for the corresponding cell, and the network device 130 is configured with a plurality of beams 130-1 which provide coverage for the corresponding cell.

For illustrative purposes, the network device 120, 130 and terminal device 110 constitute a multi-TRP deployment. As can be seen, the network device 120 may perform transmission directly with the terminal device 110, and the network device 130 may perform transmission with the terminal device 110 via a reflector 140 (such as a wall). The network devices 120 and 130 have different distances form the terminal device 110.

The network device 120 may be associated with a first TAG associated to a first TCI state and uses a first TA loop for transmission with the terminal device 110. The network device 130 may be associated with a second TAG associated to a second TCI state and uses a second TA loop for transmission with the terminal device 110.

In some scenario, the terminal device 110 may be currently in a first transmission with the network device 120, and then a second transmission between the terminal device 110 and the network device 130 (associated to the second TCI state) might be required to be newly added. However, in such a case, since the second TA loop associated to the second TCI state has not been initialized, the second transmission still needs to use the first TA loop for the second TCI state at the initial stage.

FIG. 1B illustrates another example network environment 100-2 in which example embodiments of the present disclosure may be implemented. The environment 100-2, which may be a part of a communication network, includes terminal devices and network devices.

As illustrated in FIG. 1B, the communication network 100-2 may include a terminal device 110 (hereinafter may also be referred to as user equipment 110 or a UE 110). The communication network 100-2 may further include a network device 120 (hereinafter may also be referred to as a TRP or BS).

Each network device of these network devices may manage one or more cells. The network device 120 may be configured with a plurality of beams 120-1 and 120-2 which provide coverage for the corresponding cell.

For illustrative purposes, the network device 120 and terminal device 110 constitute another multi-TRP deployment. As can be seen, the network device 120 may perform transmission directly with the terminal device 110 using the beam 120-1 in a first direction, and may also perform transmission with the terminal device 110 via a reflector 140 (such as a wall) using the beam 120-2 in a second direction. The two different transmission paths between the terminal device 110 and network device 120 have different distances.

For the first path in the first direction using beam 120-1, the network device 120 may be associated with a first TAG associated to a first TCI state and uses a first TA loop for transmission with the terminal device 110. For the second path in the second direction using beam 120-2, the network device 120 may be associated with a second TAG associated to a second TCI state and uses a second TA loop for transmission with the terminal device 110.

In some scenarios, the terminal device 110 is currently in a first transmission with the network device 120 using beam 120-1 associated to a first TCI state, and then the first transmission might be required to be switched to use the beam 120-2 associated to the second TCI state to perform signal transmit in the second direction. However, since the second TA loop associated to the second TCI state has not been initialized, similarly to activation of an additional TCI, the first transmission still needs to use the first TA loop for the second TCI state at the initial stage after the switch of TCI state.

For illustrative purposes, under the network environments shown in FIG. 1A and FIG. 1B, the terminal device could measure the timing of downlink RS for each TCI state. However, the network device 120 or 130 does not know the time of arrival (ToA) difference of downlink RS(s). Therefore, when the network device 120 or 130 schedules the terminal device 110 for uplink transmission on the second TCI state, the only timing that the terminal device 110 knows is the timing of the first TA loop for the first TCI state. Consequently, when the terminal device 110 performs uplink transmission for the second TCI state, the timing may be misaligned that the uplink transmission for the second TCI state may not be decoded accurately or may be lost. In such a case, the terminal device 110 may use the long CP to transmit the uplink signals as described hereinafter.

It is to be understood that the number of network devices and terminal devices is given only for the purpose of illustration without suggesting any limitations. The systems 100-1 and 100-2 may include any suitable number of network devices and/or terminal devices adapted for implementing embodiments of the present disclosure. Although not shown, it would be appreciated that one or more terminal devices may be located in the environment 100-1 and 100-2.

Communications in the network environment 100-1 and 100-2 may be implemented according to any proper communication protocol(s), comprising, but not limited to, the third generation (3G), the fourth generation (4G), the fifth generation (5G) or beyond, wireless local network communication protocols such as institute for electrical and electronics engineers (IEEE) 802.11 and the like, and/or any other protocols currently known or to be developed in the future. Moreover, the communication may utilize any proper wireless communication technology, comprising but not limited to: multiple-input multiple-output (MIMO), orthogonal frequency division multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), carrier aggregation (CA), dual connection (DC), and new radio unlicensed (NR-U) technologies.

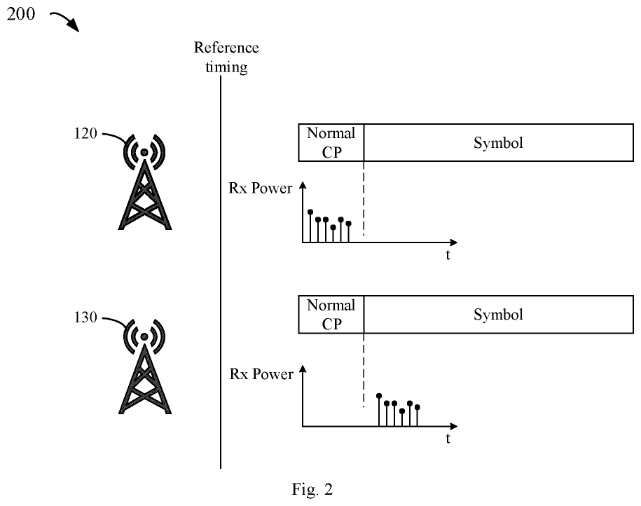

For illustrative purposes, reference will be further made to FIG. 2 to describe some example scenarios requiring the solution as proposed herein. FIG. 2 illustrates an example schematic drawing 200 showing receiving power of uplink signals using a normal CP at two network devices. For illustrative purposes, the TCI state addition scenario is taken as an example, and similar description can be applied to the TCI state switching scenario, too.

In FIG. 2, it is assumed that the terminal device 110 is sending a first uplink transmission to the network device 120 belonging to a first TAG using a first TA loop associated to a first TCI state. As illustrated, the uplink transmission may be received by the network device 120 inside a normal CP duration, that is, the uplink transmission may be successfully received. Afterwards, due to triggering of the TCI state addition, the terminal device 110 is sending a second uplink transmission to the network device 130 belonging to a second TAG associated to a second TCI state.

However, since the second TA loop for the second TAG has not been configured, the second uplink transmission might still use the first TA loop for the first TAG. In such a case, the second uplink transmission might be received outside the normal CP. Thus, the second uplink transmission will be highly degraded or lost at the network device 130 due to timing misalignment.

To solve the timing misalignment due to new TCI state introduced by such as TCI state addition or TCI state switch, in the present disclosure, the second uplink transmission associated to the second TCI state is scheduled to occur in a long CP so as to absorb more delays and ensure detecting the uplink transmission for the new TCI state, thus ensuring that the uplink transmission for the new TCI state is less likely to be degraded or lost and enhancing timing alignment.

Particularly, the inventors notice that each subframe includes a plurality of symbols, wherein some symbols have a normal CP length while other symbols have a long CP length. The long CP has a time duration longer than (about twice) the normal CP. Therefore, the present disclosure proposes to intentionally using the long CP to transmit the uplink signals.

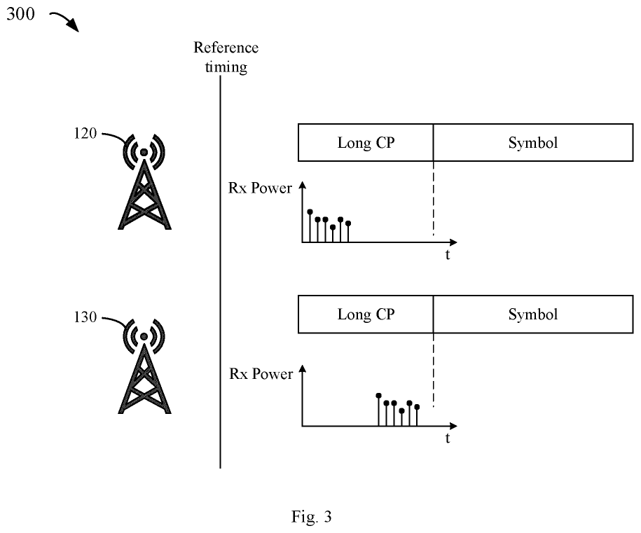

FIG. 3 illustrates an example schematic drawing 300 showing receiving power of uplink signals using a long CP respectively at two network devices. In FIG. 3, the TCI state addition scenario is still taken as an example, similar description can be applied to the TCI state switching scenario, too.

In FIG. 3, it is also assumed that the terminal device 110 is sending a first uplink transmission to the network device 120 belonging to a first TAG using a first TA loop associated to a first TCI state. As illustrated, the uplink transmission may be received by the network device 120 inside a long CP duration, that is, the uplink transmission may be successfully received.

Afterwards, the terminal device 110 will send a second uplink transmission to the network device 130 belonging to a second TAG associated to a second TCI state. In this case, although the second uplink transmission still uses the first TAG configuration, the second uplink transmission can be successfully received since the long CP has a longer time duration and thus absorb more delays. Therefore, the second uplink transmission may be detected by the network device 130 without degradation.

In some embodiments, the systems 100-1 and 100-2 may operate with certain sub carrier spacing (SCS). For example, certain SCS may be 15 kHz, 30 kHz, 60 kHz, 120 kHz or 240 kHz. For illustrative purposes, the systems 100-1 and 100-2 may operate with 120 kHz SCS, in which each subframe consists of 112 symbols, among which 110 symbols have a normal CP length of 586 ns, and 2 symbols have a long CP length of 1107 ns.

The long CP duration occasions may occur each half-subframe (i.e., 0.5 ms). Assuming that the network device 120 or 130 will use ⅓ of the normal CP length for target uplink timing, the delays the network device can estimate within the normal CP is CPₙₒᵣₘₐₗ−⅓ CPₙₒᵣₘₐₗ≈391 ns, while the delays the network device can estimate within the long CP is CP_{long}−⅓ CPₙₒᵣₘₐₗ≈912 ns. As such, in long symbols using the long CP, the network device 120 or 130 can detect delays more than twice as long as for the symbols using the normal CP.

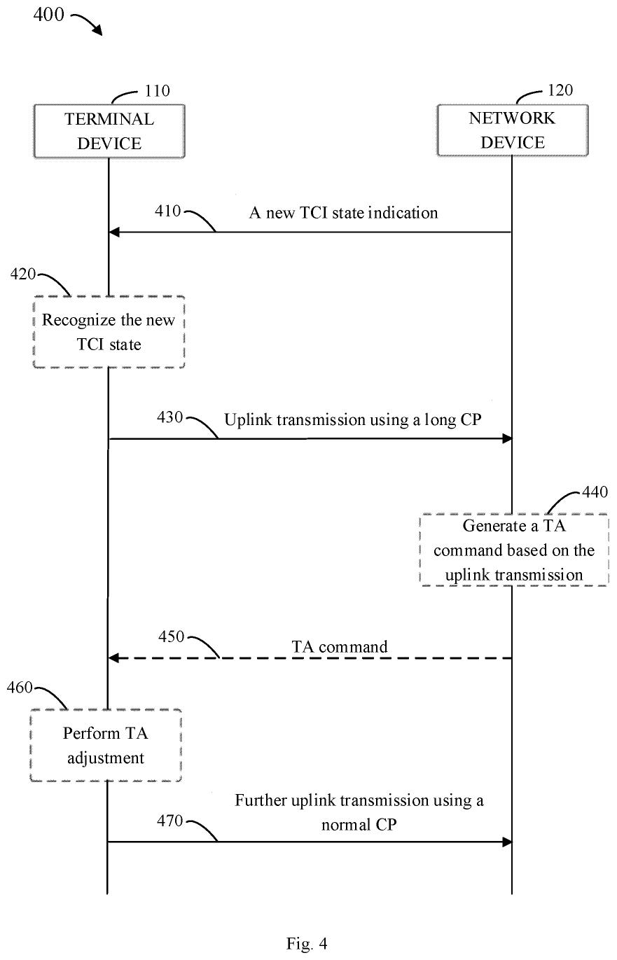

Next, reference will be made to FIGS. 4 to 8 to describe some of example embodiments of the present disclosure to enable the skilled in the art to better understand the principles of the present disclosure.

FIG. 4 illustrates an example signaling process 400 for uplink transmission using a long CP upon activation of an additional TCI state according to some embodiments of the present disclosure. The process 400 may involve the terminal device 110 and network devices 120 and 130 as illustrated in FIG. 1A and FIG. 1B. It would be appreciated that although the process 400 has been described according to the communication environments 100-1 and 100-2 of FIG. 1A and FIG. 1B, this process may be likewise applied to other communication scenarios with similar issues.

In the process 400, at 410, the terminal device 110 may receive a new TCI state indication from a network device. The new TCI state indication may indicate a new TCI state is to be used for uplink signal transmission. In some embodiments, the network device as mentioned above may be the network device providing the serving cell of the terminal device 110, for example, the network device 120. Alternatively, the network device may be also the network device 130. Without any limitation, in the following embodiments, the network device 120 will be taken as an example of the serving cell of the terminal device to describe embodiments of the present disclosure.

In some embodiments, the new TCI state indication may indicate any of the following: a new uplink signal transmission to the network device 120 associated with the new TCI state; or switching the uplink signal transmission to the network device 120 to the new TCI state from a previous TCI state. In other words, the new TCI state indication may indicate newly adding a TCI state under TCI state addition scenario, or may indicate switching to a new TCI state under TCI state switching scenario.

With the new TCI state indication received, the terminal device 110 may recognize 420 the new TCI state introduced by such as TCI state addition or switch, and prepare to perform the following uplink transmission for the new TCI state.

Then, the terminal device 110 may transmit 430, to the network device 120, at least one uplink signal using a long CP, based on the new TCI state. In some embodiments, the terminal device 110 may transmit 430, to the network device 120, the at least one uplink signal using the long CP in at least one uplink channel based on the new TCI state.

In some embodiments, the terminal device 110 may determine or may be configured to transmit at least one predetermined certain uplink signals/channels for the new TCI state, and not transmit other uplink channels/signals for the new TCI state until receiving a TA command corresponding to the new TCI state from the network device 120.

In some embodiments, at least one predetermined certain uplink signals may comprise uplink signals scheduled or configured to be transmitted in symbols with the long CP. Those uplink signals may comprise one or more of: uplink sounding reference signal (SRS), uplink demodulation reference signal (DMRS) or uplink phase tracking reference signal (PTRS).

In some embodiments, at least one predetermined certain uplink channels may comprise uplink channels scheduled or configured to be transmitted in symbols with the long CP. Those uplink channels may comprise one or more of: physical uplink control channel (PUCCH), PUCCH with a certain format or physical uplink shared channel, PUSCH.

In some embodiments, the uplink signal transmission using the long CP from the terminal device 110 to the network device 120 may be triggered implicitly. For example, the uplink signal transmission using the long CP from the terminal device 110 to the network device 120 may be triggered when the at least one predetermined uplink signal or the at least one predetermined uplink channel are configured with one or more resources or one or more resource sets for the new TCI state, such as the SRS resource.

Additionally or alternatively, the uplink signal transmission using the long CP from the terminal device 110 to the network device 120 may be triggered when the new TCI state belongs to TCI states configured for uplink signal transmission using the long CP. In other words, some certain TCI states may be preconfigured by for example, the terminal device 110 or the network device 120 to use the long CP. Thus, when the new TCI state belongs to the preconfigured certain TCI states, the uplink signal transmission using the long CP will be triggered.

Additionally or alternatively, the uplink signal transmission using the long CP from the terminal device 110 to the network device 120 may be triggered when the new TCI state belongs to certain TCI states. The certain TCI states may correspond to at least one of a certain network device, a certain coreset pool index, or a certain PCI, configured for uplink signal transmission using the long CP. In other words, some certain network device, coreset pool index or PCI may be preconfigured by the terminal device 110 or the network device 120 to use the long CP. Thus, if the new TCI state belongs to those TCI states corresponding to the preconfigured certain network device, coreset pool index or PCI, the uplink signal transmission using the long CP will be triggered. Therefore, the solution as proposed herein may be applied for the inter-cell multi-TRP operation or the intra-cell multi-TRP operation.

In some embodiments, the uplink signal transmission using the long CP from the terminal device 110 to the network device 120 may be triggered explicitly. For example, the terminal device 110 may receive, from the network device 120, a trigger command for uplink signal transmission using the long CP.

In some embodiments, the trigger command may be contained in a same downlink message containing the new TCI state indication. In some embodiments, the downlink message may include at least one of the following: DCI or medium access control (MAC) control element (CE). The trigger command may be represented by such as a bit field or a bit set to a specific value. Additionally or alternatively, if the downlink message containing the new TCI state indication does not include the trigger command, the uplink signal transmission using the long CP for the new TCI state could be omitted.

In some embodiments, the uplink signal transmission using the long CP may be performed by the terminal device 110 when at least one predetermined condition is satisfied. For example, the uplink signal transmission using the long CP is performed by the terminal device 110 when a timing difference between downlink timings associated with the new TCI state and a previous TCI state is equal to or greater than a predetermined timing difference limit. In fact, such timing difference might be smaller than the predetermined timing difference limit, it might imply that the issues as proposed herein might not occur and thus the uplink signal transmission using the long CP may not be performed to reduce unnecessary operations.

In some embodiments, the predetermined timing difference limit may be configured by the network device 120 or the terminal device 110. Additionally or alternatively, the timing difference limit may be expressed in the TA steps. If the new TA value associated with the new TCI state exceeds the autonomous allowed step size for the timing adjustment of the terminal device 110, the terminal device 110 will perform the uplink signal transmission using the long CP. In some embodiments, the terminal device 110 may determine whether there is no need to perform uplink transmission using the long CP based on the predetermined timing difference limit.

Additionally or alternatively, the uplink signal transmission using the long CP may be performed by the terminal device 110 when the duration of the long CP is sufficient for timing adjustment for the new TCI state. In some embodiments, the network device 120 infers that the duration of the long CP is sufficient if detecting the uplink transmission for the new TCI state before a timer expiry or a maximum number of transmissions reaching.

Additionally or alternatively, the uplink signal transmission using the long CP may be performed by the terminal device 110 when a TA command includes a TAG ID associated with the new TCI state but has no valid TA value. In other words, if the TA command includes a TAG ID associated with the new TCI state but has no valid TA value, the terminal device 110 could know that a new TA loop is to be activated and the uplink signal transmission using the long CP needs to be performed.

In the existing solutions, an absolute TA command (TAC) does not have any TAG ID since it is transmitted as part of the RA procedure. With the proposed solution, the medium access control, MAC, control element, CE, may carry any identifier that the command is an absolute TA value.

In this case, the absolute TAC may include TAG ID. Thus, if the TAG ID corresponds to a TAG ID that has no valid TA, the terminal device 110 assumes a TA loop to be activated associated with the TAG ID. When the terminal device 110 receives a TCI state activation without “valid TAG” information, the UE may activate a timer and trigger preconfigured uplink SRS transmission associated with uplink TX occasions with long CP.

In some embodiments, the terminal device 110 may trigger a random access channel (RACH) transmission to request a TA value associated with the new TCI state based on at least one predetermined fallback condition. An RACH transmission may be a fallback option to initialize the second TA loop for the new TCI state, which will overconsume the resources.

In the present disclosure, the RACH transmission could be a fallback option for initializing the second TA loop for the new TCI state. In some embodiments, the RACH transmission may be triggered by the TCI state indication based on the at least one predetermined fallback condition. For example, when the long CP transmission scheme is not applicable or could not deal with the long relative distance between the network devices, the RACH transmission may be triggered.

In some embodiments, the terminal device 110 may trigger a RACH transmission to request a TA value associated with the new TCI state when the duration of the long CP is insufficient for timing adjustment for the new TCI state. That is to say, although the long CP could absorb more delays than the normal CP, sometimes the long CP is still insufficient for timing adjustment. In such a scenario, it will also have timing misalignment issues even if the long CP transmission scheme is used and thus the RACH procedure needs to be triggered.

In some embodiments, the network device 120 may infer that the duration of the long CP is insufficient if no uplink transmission for the new TCI state is detected before a timer expiry or a maximum number of transmissions reaching. In some embodiments, the timer and the maximum number of transmissions may be configured by the network device 120.

Additionally or alternatively, the terminal device 110 may trigger a RACH transmission to request a TA value associated with the new TCI state when the uplink signal transmission using the long CP is already performed a maximum number of times or for a predetermined period of time. If the terminal device 110 still has not received a TA command corresponding to the new TCI state after the maximum number of times or the predetermined period of time, the terminal device 110 may use the RACH transmission to request TA corresponding to the new TCI state.

In some embodiments, the network device 120 may optionally transmit a threshold configuration to the terminal device 110, wherein the threshold configuration may indicate a maximum number of times or a predetermined period of time for the uplink signal transmission using the long CP.

In some embodiments, the network device 120 may generate 440 a TA command for TA adjustment based on the at least one uplink signal received from the terminal device 110 associated with the new TCI state using the long CP. Additionally, the network device 120 may transmit 450 the TA command to the terminal device 110. Thereafter, the terminal device 110 may perform TA adjustment for the new TCI state according to the TA information in the TA command.

In some embodiments, after receiving the TA command, the terminal device 110 may transmit 470, to the network device 120, a further uplink signal the new TCI state using a normal CP based on the TA command. That is to say, the following uplink transmission after TA adjustment could use the normal CP as usual since the second TA loop is already initialized successfully. In some embodiments, the further uplink signal may be transmitted in the at least one uplink channel associated with the new TCI state using a normal CP based on the TA command.

In view of the above, it can be seen that the embodiments of the present disclosure could absorb more delays and ensure detecting the uplink transmission for the new TCI state due to usage of the long CP transmission solution. Therefore, it is possible to ensure that the uplink transmission for the new TCI state is less likely to be degraded or lost and thereby enhance timing alignment TA. In comparison with using the RACH procedure to perform timing alignment, the long CP transmission scheme of the present disclosure could be performed more frequently, uses fewer resources and reduces much latency for the new TCI state, which improve the system performance substantially.

For example, as for a PRACH configuration index for FR2 in 120 kHz, there are eight PRACH occasions, in which each occasion may have a periodicity of 20 slots. In the present disclosure, the long CP transmission scheme may be performed twice per subframe with a periodicity of 4 slots. Therefore, in comparison with the RACH procedure, the long CP transmission scheme of the present disclosure could reduce latency for new TCI state by factor 5.

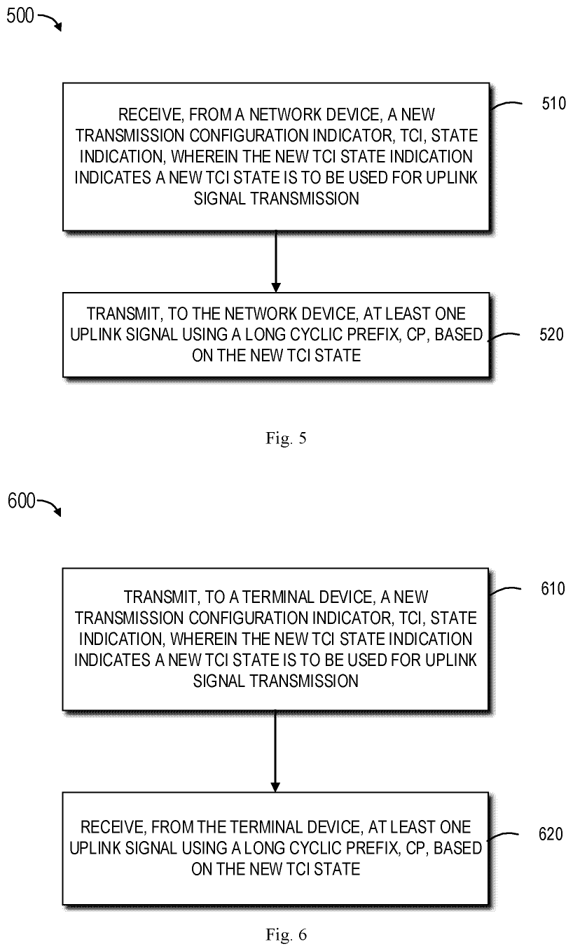

FIG. 5 illustrates an example flowchart of a method implemented at a terminal device (for example, the terminal device 110) according to example embodiments of the present disclosure. For the purpose of discussion, the method 500 will be described from the perspective of the terminal device 110 with reference to FIG. 1A and FIG. 1B.

At 510, the terminal device 110 may receive from a network device 120, a new TCI state indication. The new TCI state indication may indicate a new TCI state is to be used for uplink signal transmission. At 520, the terminal device 110 may transmit, to the network device 120, at least one uplink signal using a long cyclic prefix, CP, based on the new TCI state.

In some embodiments, the new TCI state indication may indicate any of the following: a new uplink signal transmission to the network device 120 associated with the new TCI state; or switching the uplink signal transmission to the network device 120 to the new TCI state from a previous TCI state.

In some embodiments, the terminal device 110 may transmit the at least one uplink signal using the long CP in at least one uplink channel based on the new TCI state. In some embodiments, the at least one uplink signal may comprise at least one predetermined uplink signal. In some embodiments, the at least one predetermined uplink signal may comprise uplink signals scheduled or configured to be transmitted in symbols with the long CP. In some embodiments, the at least one uplink channel comprises at least one predetermined uplink channel. Alternatively or additionally, the at least one predetermined uplink channel may comprise uplink channels scheduled or configured to be transmitted in symbols with the long CP.

In some embodiments, the at least one predetermined uplink signal may comprise one or more of: SRS; DMRS; or PTRS. In some embodiments, the at least one predetermined uplink channel may comprise one or more of: PUCCH; PUCCH with a certain format; or PUSCH.

In some embodiments, the uplink signal transmission using the long CP may be triggered when the at least one predetermined uplink signal or the at least one predetermined uplink channel are configured with one or more resources or one or more resource sets for the new TCI state.

In some embodiments, the uplink signal transmission using the long CP may be triggered when the new TCI state belongs to TCI states configured for uplink signal transmission using the long CP. In some embodiments, the uplink signal transmission using the long CP may be triggered when the new TCI state belongs to TCI states corresponding to at least one of a certain network device, a certain coreset pool index, or a certain physical cell identifier, PCI, configured for uplink signal transmission using the long CP.

In some embodiments, in method 500, the terminal device 110 may receive, from the network device 120, a trigger command for uplink signal transmission using the long CP. In some embodiments, the trigger command may be contained in a same message containing the new TCI state indication. In some embodiments, the message includes at least one of the following: DCI or MAC CE.

In some embodiments, the uplink signal transmission using the long CP may be performed when at least one predetermined condition is satisfied. In some embodiments, the at least one predetermined condition may comprise one or more of: a timing difference between downlink timings associated with the new TCI state and a previous TCI state is equal to or greater than a predetermined timing difference limit; or the duration of the long CP is sufficient for timing adjustment for the new TCI state; or a TA command includes a TA group, TAG, ID associated with the new TCI state but has no valid TA value.

In some embodiments, in method 500, the terminal device 110 may trigger a RACH transmission to request a TA value associated with the new TCI state based on at least one predetermined fallback condition. In some embodiments, the at least one predetermined fallback condition may comprise: the duration of the long CP is insufficient for timing adjustment for the new TCI state; or the uplink signal transmission using the long CP is already performed a maximum number of times or for a predetermined period of time. In some embodiments, In method 500, the terminal device 110 may receive a threshold configuration from the network device 120, wherein the threshold configuration may indicate the maximum number of times or the predetermined period of time.

In some embodiments, In method 500, the terminal device 110 may receive, from the network device 120, a TA command associated with the new TCI state for TA adjustment, after transmitting the at least one uplink signal using a long CP. In some embodiments, In method 500, the terminal device 110 may transmit, to the network device 120, a further uplink signal based on the new TCI state using a normal CP based on the TA command. In some embodiments, the further uplink signal may be transmitted in the at least one uplink channel associated with the new TCI state using a normal CP based on the TA command.

FIG. 6 illustrates an example flowchart of a method 600 implemented at a network device (for example, the network device 120) according to example embodiments of the present disclosure. For the purpose of discussion, the method 600 will be described from the perspective of the network device 120 with reference to FIG. 1A and FIG. 1B.

At 610, the network device 120 may transmit, to a terminal device 110, a new TCI state indication. The new TCI state indication may indicate a new TCI state is to be used for uplink signal transmission. At 620, the network device 120 may receive, from the terminal device 110, at least one uplink signal using a long CP based on the new TCI state.

In some embodiments, the new TCI state indication may indicate any of the following: a new uplink signal transmission to the network device associated with the new TCI state; or switching the uplink signal transmission to the network device to the new TCI state from a previous TCI state.

In some embodiments, the network device 120 may receive the at least one uplink signal using the long CP in at least one uplink channel based on the new TCI state. In some embodiments, the at least one uplink signal may comprise at least one predetermined uplink signal, and the at least one predetermined uplink signal comprise uplink signals scheduled or configured to be transmitted in symbols with the long CP. In some embodiments, the at least one uplink channel comprises at least one predetermined uplink channel, and the at least one predetermined uplink channel may comprise uplink channels scheduled or configured to be transmitted in symbols with the long CP. In some embodiments, the at least one predetermined uplink signal may comprise one or more of: SRS; DMRS; or PTRS. In some embodiments, the at least one predetermined uplink channel may comprise one or more of: PUCCH; PUCCH with a certain format; or PUSCH.

In some embodiments, in the method 600, the network device 120 configures the at least one predetermined uplink signal or the at least one predetermined uplink channel with one or more resources or one or more resource sets for the new TCI state. In some embodiments, In the method 600, the network device 120 configures TCI states for uplink signal transmission using the long CP; and/or configures TCI states corresponding to at least one of a certain network device, a certain coreset pool index, or a certain PCI, configured for uplink signal transmission using the long CP.

In some embodiments, in the method 600, the network device 120 transmits, to the terminal device 110, a trigger command for uplink signal transmission using the long CP. In some embodiments, the trigger command may be contained in a same message containing the new TCI state indication. In some embodiments, the message includes at least one of the following: DCI or MAC CE.

In some embodiments, in the method 600, the network device 120 determines that the duration of the long CP is insufficient for timing adjustment for the new TCI state; wherein the new TCI state indication is used to further trigger a RACH transmission.

In some embodiments, in the method 600, the network device 120 transmits a threshold configuration to the terminal device 110, wherein the threshold configuration may indicate a maximum number of times or a predetermined period of time for the uplink signal transmission using the long CP.

In some embodiments, In the method 600, the network device 120 may generate a TA command for TA adjustment based on the at least one uplink signal received associated with the new TCI state using the long CP; and transmit, to the terminal device 110, the TA command. In some embodiments, In the method 600, the network device 120 may receive, from the terminal device 110, a further uplink signal based on the new TCI state using a normal CP based on the TA command. In some embodiments, the further uplink signal may be received in the at least one uplink channel associated with the new TCI state using a normal CP based on the TA command.

In some embodiments, an apparatus capable of performing any of operations of the method 500 (for example, the terminal device 110) may include means for performing the respective steps of the method 500. The means may be implemented in any suitable form. For example, the means may be implemented in a circuitry or software module.

In some embodiments, the apparatus may include means for receiving, from a network device 120, a new TCI state indication. The new TCI state indication may indicate a new TCI state is to be used for uplink signal transmission. The apparatus may further include means for transmitting, to the network device 120, at least one uplink signal using a long CP based on the new TCI state.

In some embodiments, the new TCI state indication may indicate any of the following: a new uplink signal transmission to the network device 120 associated with the new TCI state; or switching the uplink signal transmission to the network device 120 to the new TCI state from a previous TCI state.

In some embodiments, the apparatus may further include means for transmitting the at least one uplink signal using the long CP in at least one uplink channel based on the new TCI state. In some embodiments, the at least one uplink signal may comprise at least one predetermined uplink signal, and the at least one predetermined uplink signal comprise uplink signals scheduled or configured to be transmitted in symbols with the long CP. In some embodiments, the at least one uplink channel comprises at least one predetermined uplink channel, and the at least one predetermined uplink channel comprise uplink channels scheduled or configured to be transmitted in symbols with the long CP.

In some embodiments, the at least one predetermined uplink signal may comprise one or more of: SRS; DMRS; or PTRS. In some embodiments, the at least one predetermined uplink channel may comprise one or more of: PUCCH; PUCCH with a certain format; or PUSCH.

In some embodiments, the uplink signal transmission using the long CP may be triggered when the at least one predetermined uplink signal or the at least one predetermined uplink channel are configured with one or more resources or one or more resource sets for the new TCI state.

In some embodiments, the uplink signal transmission using the long CP may be triggered when the new TCI state belongs to TCI states configured for uplink signal transmission using the long CP, or when the new TCI state belongs to TCI states corresponding to at least one of a certain network device, a certain coreset pool index, or a certain physical cell identifier, PCI, configured for uplink signal transmission using the long CP.

In some embodiments, the apparatus further may include means for receiving, from the network device 120, a trigger command for uplink signal transmission using the long CP. In some embodiments, the trigger command is contained in a same message containing the new TCI state indication. In some embodiments, the message includes at least one of the following: DCI or MAC CE.

In some embodiments, the uplink signal transmission using the long CP is performed when at least one predetermined condition is satisfied. In some embodiments, the at least one predetermined condition may comprise one or more of: a timing difference between downlink timings associated with the new TCI state and a previous TCI state is equal to or greater than a predetermined timing difference limit; or the duration of the long CP is sufficient for timing adjustment for the new TCI state; or a TA command includes a TA group, TAG, ID associated with the new TCI state but has no valid TA value.

In some embodiments, the apparatus further may include means for triggering a RACH transmission to request a TA value associated with the new TCI state based on at least one predetermined fallback condition. In some embodiments, the at least one predetermined fallback condition may comprise: the duration of the long CP is insufficient for timing adjustment for the new TCI state; or the uplink signal transmission using the long CP is already performed a maximum number of times or for a predetermined period of time.

In some embodiments, the apparatus further may include means for receiving a threshold configuration from the network device 120, wherein the threshold configuration may indicate the maximum number of times or the predetermined period of time.

In some embodiments, the apparatus further may include means for receiving, from the network device 120, a TA command associated with the new TCI state for TA adjustment, after transmitting the at least one uplink signal using a long CP. In some embodiments, the apparatus further may include means for transmitting, to the network device 120, a further uplink signal based on the new TCI state using a normal CP based on the TA command. In some embodiments, the further uplink signal may be transmitted in the at least one uplink channel associated with the new TCI state using a normal CP based on the TA command.

In some embodiments, an apparatus capable of performing any of the method 600 (for example, the network device 120) may include means for performing the respective steps of the method 600. The means may be implemented in any suitable form. For example, the means may be implemented in a circuitry or software module.

In some embodiments, the apparatus may further include means for transmitting, to a terminal device 110, a new TCI state indication. The new TCI state indication may indicate a new TCI state is to be used for uplink signal transmission. In some embodiments, the apparatus may further include means for receiving, from the terminal device 110, at least one uplink signal using a long CP based on the new TCI state.

In some embodiments, the new TCI state indication may indicate any of the following: a new uplink signal transmission to the network device associated with the new TCI state; or switching the uplink signal transmission to the network device to the new TCI state from a previous TCI state.

In some embodiments, the apparatus may further include means for receiving the at least one uplink signal using the long CP in at least one uplink channel based on the new TCI state. In some embodiments, the at least one uplink signal may comprise at least one predetermined uplink signal, and the at least one predetermined uplink signal comprise uplink signals scheduled or configured to be transmitted in symbols with the long CP. In some embodiments, the at least one uplink channel comprises at least one predetermined uplink channel, and the at least one predetermined uplink channel comprise uplink channels scheduled or configured to be transmitted in symbols with the long CP. In some embodiments, the at least one predetermined uplink signal may comprise one or more of: SRS; DMRS; or PTRS. In some embodiments, the at least one predetermined uplink channel may comprise one or more of: PUCCH; PUCCH with a certain format; or PUSCH.

In some embodiments, the apparatus may further include means for configuring the at least one predetermined uplink signal or the at least one predetermined uplink channel with one or more resources or one or more resource sets for the new TCI state. In some embodiments, the apparatus may further include means for configuring TCI states for uplink signal transmission using the long CP; and/or configures TCI states corresponding to at least one of a certain network device, a certain coreset pool index, or a certain PCI, configured for uplink signal transmission using the long CP.

In some embodiments, the apparatus may further include means for transmitting, to the terminal device 110, a trigger command for uplink signal transmission using the long CP. In some embodiments, the trigger command may be contained in a same message containing the new TCI state indication. In some embodiments, the message includes at least one of the following: DCI or MAC CE.

In some embodiments, the apparatus may further include means for determining that the duration of the long CP is insufficient for timing adjustment for the new TCI state; wherein the new TCI state indication is used to further trigger a RACH transmission.

In some embodiments, the apparatus may further include means for transmitting a threshold configuration to the terminal device 110, wherein the threshold configuration may indicate a maximum number of times or a predetermined period of time for the uplink signal transmission using the long CP.

In some embodiments, the apparatus may further include means for generating a TA command for TA adjustment based on the at least one uplink signal received associated with the new TCI state using the long CP; and transmitting, to the terminal device 110, the TA command. In some embodiments, the apparatus may further include means for receiving, from the terminal device 110, a further uplink signal based on the new TCI state using a normal CP based on the TA command. In some embodiments, the further uplink signal may be received in the at least one uplink channel associated with the new TCI state using a normal CP based on the TA command.

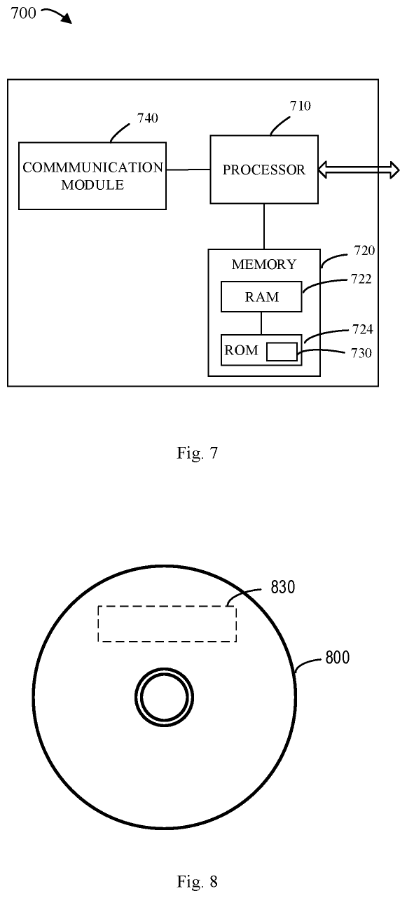

FIG. 7 is a simplified block diagram of a device 700 that is suitable for implementing embodiments of the present disclosure. The device 700 may be provided to implement the communication device, for example the terminal device 110 as shown in FIG. 1. As shown, the device 700 includes one or more processors 710, one or more memories 720 coupled to the processor 710, and one or more communication modules (such as transmitters and/or receivers (TX/RX)) 740 coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a read only memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The computer program 730 may be stored in the ROM 724. The processor 710 may perform any suitable actions and processing by loading the program 730 into the RAM 722.

The embodiments of the present disclosure may be implemented by means of the program so that the device 700 may perform any process of the disclosure as discussed with reference to FIG. 3 to FIG. 6. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out process 400, the method 500 or 600 as described above with reference to FIG. 3 to FIG. 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-42. (canceled)

43. A terminal device comprising:
at least one processor; and
at least one memory including computer program codes, wherein the at least one memory and the computer program codes are configured to, with the at least one processor, cause the terminal device to:
receive, from a network device, a new transmission configuration indicator (TCI) state indication, wherein the new TCI state indication indicates a new TCI state is to be used for uplink signal transmission; and
transmit, to the network device, at least one uplink signal using a long cyclic prefix (CP) based on the new TCI state.

44. The terminal device of claim 43, wherein the new TCI state indication indicates any of the following:
a new uplink signal transmission to the network device associated with the new TCI state; or
switching the uplink signal transmission to the network device to the new TCI state from a previous TCI state.

45. The terminal device of claim 43, wherein transmit at least one uplink signal using a long CP based on the new TCI state comprises:
transmitting the at least one uplink signal using the long CP in at least one uplink channel based on the new TCI state.

46. The terminal device of claim 45, wherein
the at least one uplink channel comprises at least one predetermined uplink channel, and the at least one predetermined uplink channel comprise uplink channels scheduled or configured to be transmitted in symbols with the long CP.

47. The terminal device of claim 46, wherein the at least one predetermined uplink channel comprises one or more of:
physical uplink control channel, PUCCH;
PUCCH with a certain format; or
physical uplink shared channel, PUSCH.

48. The terminal device of claim 43, wherein
the at least one uplink signal comprises at least one predetermined uplink signal, and the at least one predetermined uplink signal comprise uplink signals scheduled or configured to be transmitted in symbols with the long CP.

49. The terminal device of claim 48, wherein the at least one predetermined uplink signal comprises one or more of:
uplink sounding reference signal, SRS;
uplink demodulation reference signal, DMRS; or
uplink phase tracking reference signal, PTRS.

50. The terminal device of claim 48, wherein the uplink signal transmission using the long CP is triggered when the at least one predetermined uplink signal or the at least one predetermined uplink channel are configured with one or more resources or one or more resource sets for the new TCI state.

51. The terminal device of claim 43, wherein the uplink signal transmission using the long CP is triggered
when the new TCI state belongs to TCI states configured for uplink signal transmission using the long CP, or
when the new TCI state belongs to TCI states corresponding to at least one of a certain network device, a certain coreset pool index, or a certain physical cell identifier, PCI, configured for uplink signal transmission using the long CP.

52. The terminal device of claim 43, wherein the terminal device is further caused to:
receive, from the network device, a trigger command for uplink signal transmission using the long CP.

53. The terminal device of claim 52, wherein the trigger command is contained in a same message containing the new TCI state indication.

54. The terminal device of claim 43, wherein the uplink signal transmission using the long CP is performed when at least one predetermined condition is satisfied.

55. The terminal device of claim 54, wherein the at least one predetermined condition comprises one or more of:
a timing difference between downlink timings associated with the new TCI state and a previous TCI state is equal to or greater than a predetermined timing difference limit; or
the duration of the long CP is sufficient for timing adjustment for the new TCI state; or
a timing advance (TA) command includes a TA group (TAG) ID associated with the new TCI state but has no valid TA value.

56. The terminal device of claim 43, wherein the terminal device is further caused to:
trigger a random access channel transmission to request a TA value associated with the new TCI state based on at least one predetermined fallback condition.

57. The terminal device of claim 56, wherein the at least one predetermined fallback condition comprises:
the duration of the long CP is insufficient for timing adjustment for the new TCI state; or
the uplink signal transmission using the long CP is already performed a maximum number of times or for a predetermined period of time.

58. The terminal device of claim 57, wherein the terminal device is further caused to:
receive a threshold configuration from the network device, wherein the threshold configuration indicates the maximum number of times or the predetermined period of time.

59. The terminal device of claim 43, wherein the terminal device is further caused to:
receive, from the network device, a TA command associated with the new TCI state for TA adjustment, after transmitting the at least one uplink signal using a long CP.

60. The terminal device of claim 59, wherein the terminal device is further caused to:
transmit, to the network device, a further uplink signal based on the new TCI state using a normal CP based on the TA command.

61. A network device, comprising:
at least one processor; and
at least one memory including computer program codes, wherein the at least one memory and the computer program codes are configured to, with the at least one processor, cause the network device to:
transmit, to a terminal device, a new transmission configuration indicator (TCI) state indication, wherein the new TCI state indication indicates a new TCI state is to be used for uplink signal transmission; and
receive, from the terminal device, at least one uplink signal using a long cyclic prefix (CP) based on the new TCI state.

62. A method at a terminal device, comprising:
receiving, from a network device, a new transmission configuration indicator (TCI) state indication, wherein the new TCI state indication indicates a new TCI state is to be used for uplink signal transmission; and
transmitting, to the network device, at least one uplink signal using a long cyclic prefix (CP) based on the new TCI state.
